(19) United States
(12) Patent Application Publication
(10) Pub. No.: US 2025/0085911 A1
(43) Pub. Date: Mar. 13, 2025

(54) INFORMATION PROCESSING APPARATUS, CONTROL METHOD OF INFORMATION PROCESSING APPARATUS, PRINTING SYSTEM, AND NON-TRANSITORY COMPUTER-READABLE STORAGE MEDIUM STORING PROGRAM

(71) Applicant: SEIKO EPSON CORPORATION, Tokyo (JP)

(72) Inventor: Mikihiro KAJIHARA, Matsumoto-shi (JP)

(73) Assignee: SEIKO EPSON CORPORATION, Tokyo (JP)

(21) Appl. No.: 18/826,460

(22) Filed: Sep. 6, 2024

(30) Foreign Application Priority Data
Sep. 8, 2023 (JP) 2023-146480

(51) Int. Cl. G06F 3/12; B41J 3/407; B41J 3/46

(52) U.S. Cl. CPC G06F 3/1251; B41J 3/4075; B41J 3/46; G06F 3/1205

(57) ABSTRACT

An information processing apparatus including: a split section configured to split a print job causing a tape printing apparatus to print a plurality of labels into a plurality of split print jobs; and a transmission section configured to transmit a plurality of the split print jobs to the tape printing apparatus, wherein the transmission section performs a full cut at a rear end of a label to be printed last among one or more of the labels to be printed in accordance with the split print jobs, and when a plurality of the labels are printed in accordance with the split print jobs, the transmission section transmits a plurality of the split print jobs, the individual split print jobs with added first cut information instructing the tape printing apparatus to perform boundary formation processing between labels of a plurality of the labels, to the tape printing apparatus.

The present application is based on, and claims priority from JP Application Serial Number 2023-146480, filed Sep. 8, 2023, the disclosure of which is hereby incorporated by reference herein in its entirety.

### BACKGROUND

### 1. Technical Field

The present disclosure relates to an information processing apparatus, a control method of an information processing apparatus, a printing system, and a non-transitory computer-readable storage medium storing a program.

### 2. Related Art

As disclosed in JP-A-2020-196163, for example, at the time of printing 20 labels, when a user gives an instruction to perform a full cut every 5 labels printed, there is provided a printer that prints 5 labels consecutively and also creates 4 label sets with a half cut between labels.

On the other hand, a label printing system, in which an upper apparatus transmits a print job to a printer for printing labels, is known.

In such a related-art printing system, when the user wants to create a plurality of the label sets described above, it is necessary for the upper apparatus to generate a print job for creating 20 labels, which specifically instruct to perform a full cut every 5 labels, and perform a half cut between other labels. However, among the related-art printers, there is a printer that performs only one kind of cut, that is, either a half cut or a full cut on all of a plurality of labels in accordance with one print job. In the case of such a printer, it is not possible to perform two kinds of cut, that is, perform a full cut between specific labels and perform a half cut between the other labels in accordance with one print job. Of course, such a printer is able to perform two kinds of cut between labels in accordance with one print job by changing firmware. However, it requires some development cost and some providing cost for the firmware.

### SUMMARY

According to an aspect of the present disclosure, there is provided an information processing apparatus configured to communicate with a tape printing apparatus configured to perform feeding operation of a tape in a first direction, printing on the tape, a full cut of the tape, and boundary formation processing forming a boundary between labels on the tape, the information processing apparatus including: a split section configured to split a print job causing the tape printing apparatus to print a plurality of labels into a plurality of split print jobs; and a transmission section configured to transmit a plurality of the split print jobs to the tape printing apparatus, wherein the transmission section performs the full cut at an end in a second direction opposite to the first direction of the label to be printed last among one or more of the labels to be printed in accordance with the split print jobs, and when a plurality of the labels are printed in accordance with the split print jobs, the transmission section transmits a plurality of the split print jobs, the individual split print jobs with added first cut information instructing the tape printing apparatus to perform the boundary formation processing between labels of a plurality of the labels, to the tape printing apparatus.

According to another aspect of the present disclosure, there is provided a control method of an information processing apparatus configured to communicate with a tape printing apparatus configured to perform feeding operation of a tape in a first direction, printing on the tape, a full cut of the tape, and boundary formation processing forming a boundary between labels on the tape, the control method causing the information processing apparatus to perform processing including: splitting a print job causing the tape printing apparatus to print a plurality of labels into a plurality of split print jobs; and transmitting a plurality of the split print jobs to the tape printing apparatus, wherein in the transmitting, performing the full cut at an end in a second direction opposite to the first direction of the label to be printed last among one or more of the labels to be printed in accordance with the split print jobs, and when a plurality of the labels are printed in accordance with the split print jobs, transmitting a plurality of the split print jobs, the individual split print jobs with added first cut information instructing the tape printing apparatus to perform the boundary formation processing between labels of a plurality of the labels, to the tape printing apparatus.

According to another aspect of the present disclosure, there is provided a printing system including a tape printing apparatus configured to perform feeding operation of a tape in a first direction, printing on the tape, a full cut of the tape, and boundary formation processing forming a boundary between labels on the tape, and an information processing apparatus configured to communicate with the tape printing apparatus, the information processing apparatus including: a split section configured to split a print job printing a plurality of labels on the tape printing apparatus into a plurality of split print jobs; and a transmission section configured to transmit a plurality of the split print jobs to the tape printing apparatus, wherein the transmission section performs the full cut at an end in a second direction opposite to the first direction of the label to be printed last among one or more of the labels to be printed in accordance with the split print jobs, and when a plurality of the labels are printed in accordance with the split print jobs, the transmission section transmits a plurality of the split print jobs, the individual split print jobs with added first cut information instructing the tape printing apparatus to perform the boundary formation processing between labels of a plurality of the labels, to the tape printing apparatus.

According to another aspect of the present disclosure, there is provided a non-transitory computer-readable storage medium storing a program, the program causing an information processing apparatus configured to communicate with a tape printing apparatus configured to perform feeding operation of a tape in a first direction, printing on the tape, a full cut of the tape, and boundary formation processing forming a boundary between labels on the tape to perform processing including: splitting a print job causing the tape printing apparatus to print a plurality of labels into a plurality of split print jobs; and transmission controlling of a transmission section so that a plurality of the split print jobs are transmitted to the tape printing apparatus, wherein in the transmission controlling, performing the full cut at an end in a second direction opposite to the first direction of the label to be printed last among one or more of the labels to be printed in accordance with the split print jobs, and when a plurality of the labels are printed in accordance with the split print jobs, controlling the transmission section so that the transmission section adds first cut information instructing the tape printing apparatus to perform the boundary formation processing between labels of a plurality of the labels to the individual split print jobs, and transmits a plurality of the split print jobs, the individual split print jobs with the first cut information added, to the tape printing apparatus.

According to another aspect of the present disclosure, there is provided a non-transitory computer-readable storage medium storing a program, the program causing an information processing apparatus configured to transmit a print job to a tape printing apparatus configured to perform feeding operation of a tape in a first direction, printing on the tape, a full cut of the tape, and boundary formation processing forming a boundary between labels on the tape, to perform processing including: splitting a print job causing the tape printing apparatus to print a plurality of labels into a plurality of split print jobs; performing the full cut at an end in a second direction opposite to the first direction of the label to be printed last among one or more of the labels to be printed in accordance with the split print jobs, and when a plurality of the labels are printed in accordance with the split print jobs, adding first cut information instructing the tape printing apparatus to perform the boundary formation processing between labels of a plurality of the labels to a plurality of the individual split print jobs.

### BRIEF DESCRIPTION OF THE DRAWINGS

FIG. 1 is the system configuration diagram of a tape printing system.

FIG. 2 is an outer view of a tape printing apparatus and a tape cartridge.

FIG. 3 is a perspective view of a label created by performing a half cut and a full cut of a tape.

FIG. 4 is a diagram illustrating an example of label creation in accordance with a print job to which first cut information is added.

FIG. 5 is a diagram illustrating an example of label creation in accordance with a print job to which second cut information is added.

FIG. 6 is a diagram illustrating an example of label creation in accordance with a print job to which third cut information is added.

FIG. 7 is a block diagram of the hardware configuration of a PC and the tape printing apparatus.

FIG. 8 is a block diagram illustrating the functional configuration of the PC.

FIG. 9 is a diagram illustrating an example of an application setting screen.

FIG. 10 is a diagram illustrating an example of label creation when the total number of prints is 6, and the number of splits is 6 or more in split printing.

FIG. 11 is a diagram illustrating an example of label creation when the total number of prints is 6, and the number of splits is 2 in split printing.

FIG. 12 is a diagram illustrating an example of label creation when the total number of prints is 6, and the number of splits is 5 in split printing.

FIG. 13 is a flowchart illustrating print job transmission processing performed by the PC.

FIG. 14 is a flowchart following FIG. 13.

FIG. 15 is an explanatory diagram of a first variation and is a perspective view of a label on which a cut mark is printed as boundary formation processing.

FIG. 16 is an explanatory diagram of a second variation and is a diagram illustrating a label set on which a half cut margin is formed.

FIG. 17 is a block diagram illustrating the functional configuration of the PC according to a fourth variation.

FIG. 18 is a block diagram illustrating the functional configuration of the PC according to a fifth variation.

FIG. 19 is a block diagram illustrating the functional configuration of a smartphone according to a sixth variation.

### DESCRIPTION OF EMBODIMENTS

In the following, with reference to the attached drawings, a description will be given of an information processing apparatus, a control method of an information processing apparatus, a printing system, and a non-transitory computer-readable storage medium storing a program. In this regard, descriptions will be given in some drawings by using directions based on an XYZ orthogonal coordinate system. However, these directions are only for convenience of explanation, and do not limit the following embodiments in any way.

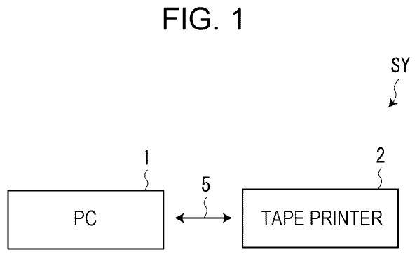

FIG. 1 is the system configuration diagram of a printing system SY. The printing system SY includes a PC (personal computer) 1 and a tape printing apparatus 2, and these devices are coupled via a cable 5 in a manner that allows communication. The PC 1 is an example of the “information processing apparatus”. In this regard, the PC 1 and the tape printing apparatus 2 may be connected via wireless communication instead of the cable 5, and may be connected via a network.

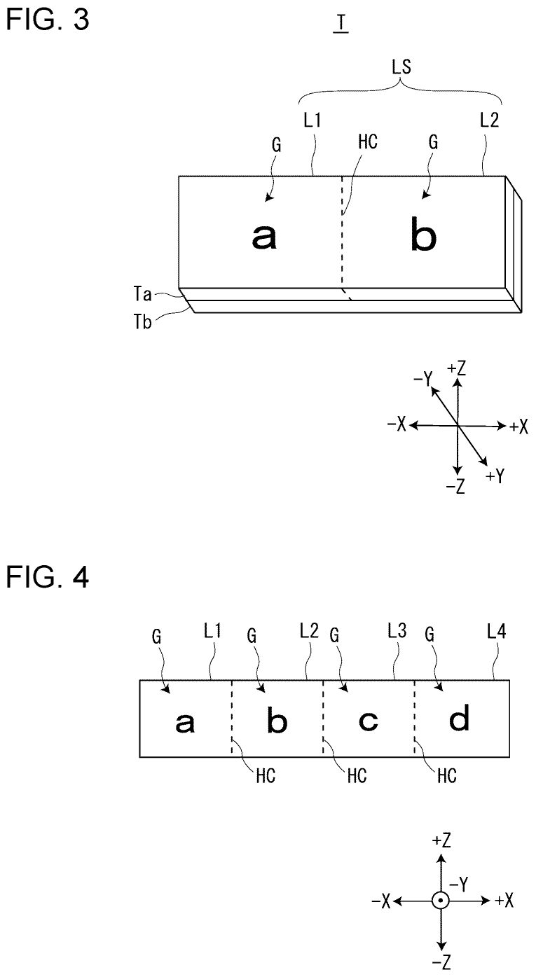

The PC 1 generates a print job for causing the tape printing apparatus 2 to create labels L illustrated in FIG. 3 and transmits the generated print job to the tape printing apparatus 2. The tape printing apparatus 2 prints label images G on a tape T in accordance with the print job transmitted from the PC 1 and performs a half cut and a full cut of the tape T so as to create the labels L. The half cut is an example of the “boundary formation processing”. A description will be given later of the half cut and the full cut.

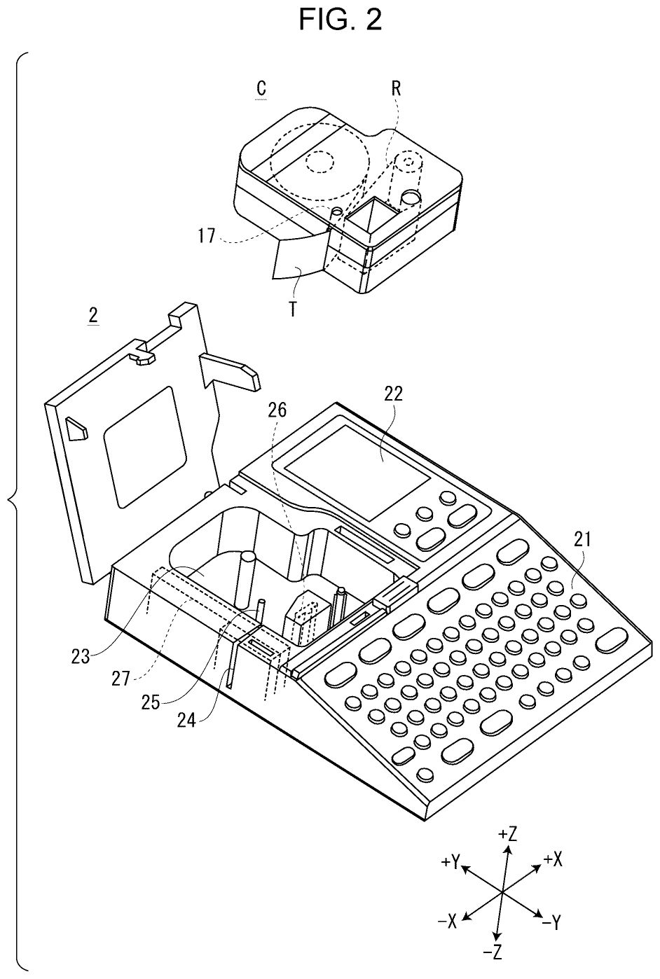

FIG. 2 is an outer view of the tape printing apparatus 2 and a tape cartridge C. The tape printing apparatus 2 includes an operation key group 21, a printer display 22, a cartridge loading section 23, and a tape discharge opening 24.

The operation key group 21 and the printer display 22 are mainly used when the tape printing apparatus 2 is operated by standalone operation. In the present embodiment, it is assumed that the tape printing apparatus 2 is operated in the state of being coupled to the PC 1 so that a description thereof will be omitted.

The tape cartridge C is loaded onto the cartridge loading section 23 in a detachable manner. The tape cartridge C contains the tape T and an ink ribbon R in its case in a rolled up state. Also, the tape cartridge C includes a platen roller 17.

As illustrated in FIG. 2, the cartridge loading section 23 includes a platen drive shaft 25 and a thermal head 26. The platen drive shaft 25 is engaged with the platen roller 17 in the state in which the tape cartridge C is loaded onto the cartridge loading section 23. The platen roller 17 feeds the tape T and the ink ribbon R in the −X-direction. The “−X-direction” is an example of the first direction.

The thermal head 26 is disposed at a position facing the platen roller 17 in the state in which the tape cartridge C is loaded onto the cartridge loading section 23. The thermal head 26 is driven to generate heat in accordance with the print job transmitted from the PC 1. Thereby, the ink of the ink ribbon R is transferred onto the tape T so that a label image G based on the print job is printed on the tape T.

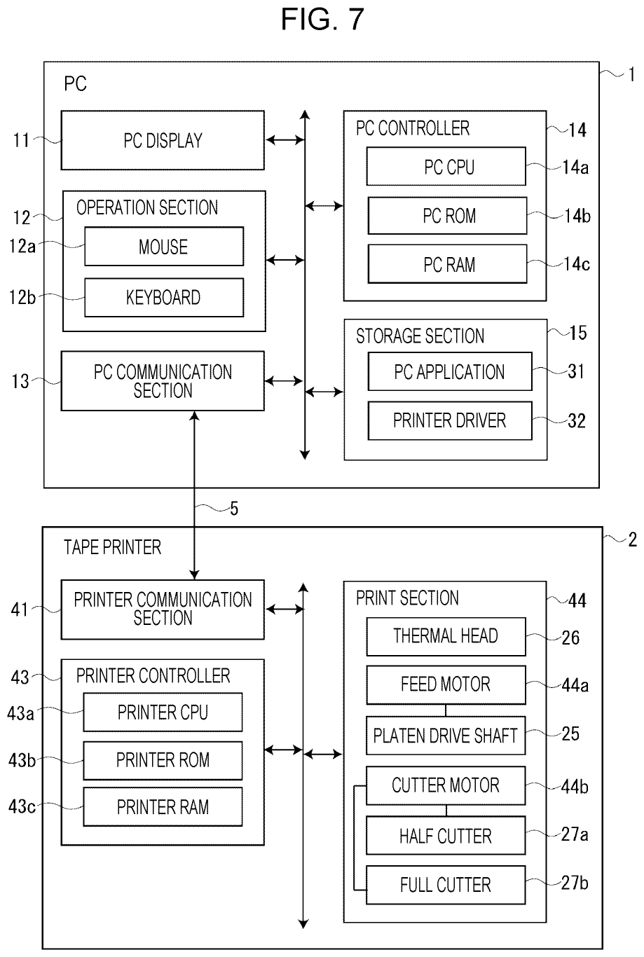

The printed tape T is ejected from the tape discharge opening 24. A cutter unit 27 is disposed between the cartridge loading section 23 and the tape discharge opening 24. As illustrated in FIG. 7, the cutter unit 27 includes a half cutter 27a and a full cutter 27b. The half cutter 27a and the full cutter 27b are driven in accordance with the print job transmitted from the PC 1.

A description will be given of a half cut and a full cut with reference to FIG. 3. FIG. 3 is a perspective view of the labels L created by performing a half cut and a full cut on the tape T. The tape T includes a print tape Ta on which printing is performed, and a release paper tape Tb laminated on the print tape Ta in the Y-direction by being pasted on the adhesive surface of the print tape Ta in a peelable manner. The surface in +Y-direction of the print tape Ta is an adhesive surface, and the release paper tape Tb is laminated in the +Y-direction of the print tape Ta.

FIG. 3 illustrates an example in which a label set LS that includes a first label L1 on which a character “a” is printed as the label image G and a second label L2 on which a character “b” is printed as the label image G is created. The label set LS refers to a set including one or more labels L, and the half cut is performed between the labels. The label set LS is created when the tape printing apparatus 2 obtains a print job to which first cut information described later is added.

The label set LS illustrated in FIG. 3 has been half cut between a first label L1 and a second label L2, and has been full cut at the end in the +X-direction of the second label L2. The +X-direction is an example of the “second direction”. Hereinafter the end in the −X-direction of the label L is referred to as a “front end of the label L”, and the end in the +X-direction of the label L is referred to as a “rear end of the label L”.

Here, a half cut is a cut using the half cutter 27a and refers to the cutting of the print tape Ta without cutting the release paper tape Tb of the tape T. In this manner, by performing the half cut of the tape T, a hack HC is formed on the print tape Ta. Since the hack HC is formed on the print tape Ta, it is possible for a user to easily separate the print tape Ta and the release paper tape Tb by using the hack HC as a clue. Also, a full cut is a cut using the full cutter 27b and refers to the cutting of both the print tape Ta of the tape T and the release paper tape Tb.

The tape printing apparatus 2 performs the half cut and the full cut of the tape T in accordance with the cut information added to the print job. Any one of the cut information among the first cut information, the second cut information, and the third cut information is added to the print job. In this regard, the PC 1 adds any one of the cut information to the print job in accordance with a cut setting of a printer driver 32 described later. When the cut setting of the printer driver 32 is the first cut setting, the PC 1 adds the first cut information to the print job. When the cut setting of the printer driver 32 is the second cut setting, the PC 1 adds the second cut information to the print job. When the cut setting of the printer driver 32 is the third cut setting, the PC 1 adds the third cut information to the print job.

FIG. 4 is an example of label creation in accordance with a print job to which the first cut information is added. The examples in FIG. 4 to FIG. 6 illustrate individual examples of label creation in accordance with the print job that prints 4 labels L from the first label L1 to the fourth label L4. In this manner, a description will be given by adding a number in accordance with the print order to each label L. In this regard, the PC 1 generates a print job that prints 4 such a plurality of labels L when editing of a plurality of labels L is performed on an edit screen not illustrated in the figures or when the number of copies is set so that a plural number of copies are printed.

When the tape printing apparatus 2 obtains a print job to which the first cut information is added, the tape printing apparatus 2 performs the half cut between all the labels of a plurality of labels L to be printed in accordance with the print job, and performs the full cut at the rear end of the label L to be printed last. Accordingly, in this case, as illustrated in FIG. 4, the tape printing apparatus 2 performs the half cut between the first label L1 and the second label L2, between the second label L2 and the third label L3, and between the third label L3 and the fourth label L4, and performs the full cut at the rear end of the fourth label L4.

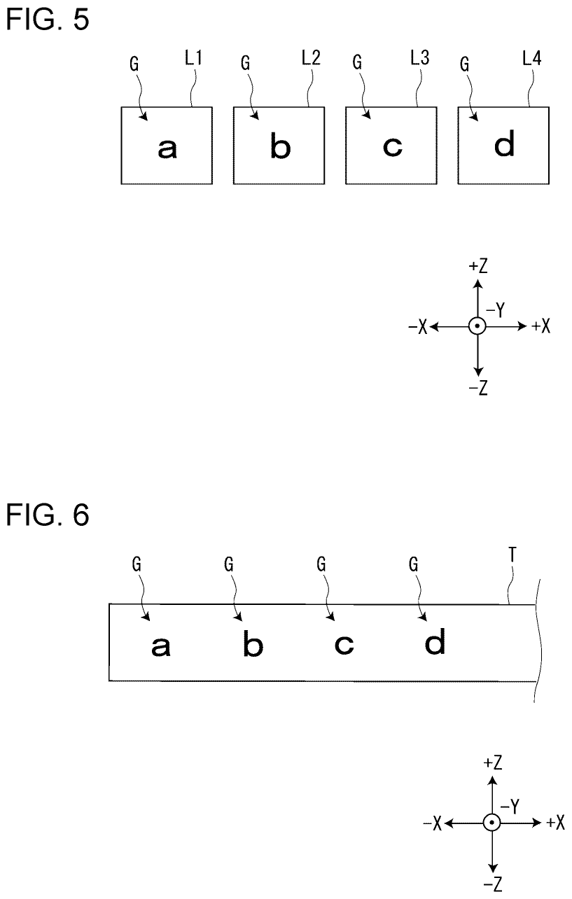

FIG. 5 is a diagram illustrating an example of label creation in accordance with a print job to which the second cut information is added. When the tape printing apparatus 2 obtains a print job to which the second cut information is added, the tape printing apparatus 2 performs the full cut at the rear end of all the labels L of a plurality of labels L to be printed in accordance with the print job. Accordingly, in this case, the tape printing apparatus 2 performs the full cut at the individual rear ends of the first label L1 to the fourth label L4 as illustrated in FIG. 5.

FIG. 6 is a diagram illustrating an example of label creation in accordance with a print job to which the third cut information is added. When the tape printing apparatus 2 obtains a print job to which the third cut information is added, the tape printing apparatus 2 does not perform any cut. The “does not perform any cut” refers to performing neither a half cut nor a full cut. Accordingly, in this case, the tape printing apparatus 2 cuts neither between the labels from the first label L1 to the fourth label L4 nor at the rear end of the fourth label L4 as illustrated in FIG. 6.

In this manner, the tape printing apparatus 2 determines whether to perform a half cut between all the labels of a plurality of labels L to be printed in accordance with a print job, perform a full cut between all the labels, or does not perform any cut between all the labels in accordance with the cut information added to the print job. That is, the tape printing apparatus 2 is not able to perform two kinds of cut between the labels in accordance with one print job, for example, to perform a full cut between specific labels and perform a half cut between the other labels, and the like.

A description will be given of the hardware configuration of the PC 1 and the tape printing apparatus 2 with reference to FIG. 7. The PC 1 includes a PC display 11, an operation section 12, a PC communication section 13, a PC controller 14, and a storage section 15. The PC display 11 is an example of the “display section”.

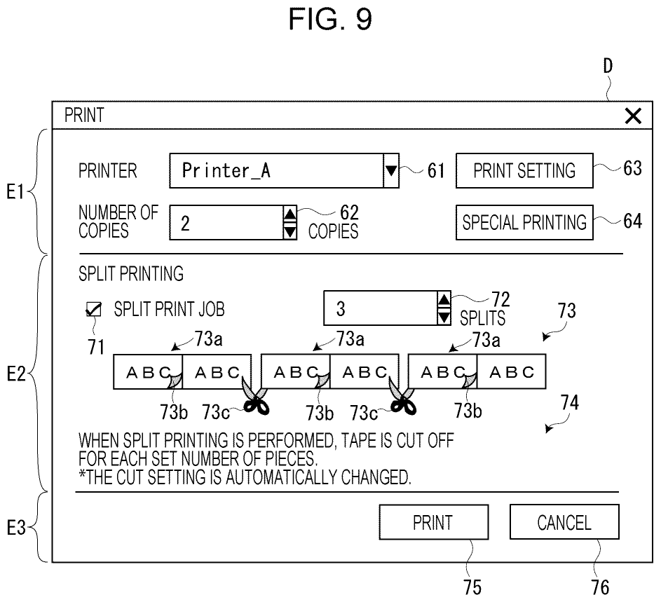

The PC display 11 displays various kinds of information, such as an application setting screen D illustrated in FIG. 9 or the like. The operation section 12 includes a mouse 12a and a keyboard 12b. In this regard, an input mechanism, such as a trackpad, a touch panel, or the like may be used instead of the mouse 12a and the keyboard 12b.

The PC communication section 13 communicates with the tape printing apparatus 2 via the cable 5. For example, the PC communication section 13 transmits a print job to the tape printing apparatus 2 and receives a response signal stating the end of the processing of a print job from the tape printing apparatus 2.

The PC controller 14 includes a PC CPU (central processing unit) 14a, a PC ROM (read only memory) 14b, and a PC RAM (random access memory) 14c.

The PC CPU 14a performs various controls by loading various programs stored in the PC ROM 14b or a storage section 15 described later to the PC RAM 14c and executing the programs. In this regard, the PC controller 14 may use a hardware circuit such as an ASIC (application specific integrated circuit) or the like as a processor instead of the PC CPU 14a. Also, the processor may have a configuration in which one or more CPUs and a hardware circuit such as an ASIC or the like work in combination.

The PC ROM 14b stores a control program and control data that do not require rewriting. Also, the PC RAM 14c is used as a work area for the PC CPU 14a to perform various kinds of control.

The storage section 15 is, for example, a hard disk drive, and stores a PC application 31 and the printer driver 32. The PC application 31 is an example of the “program”. The PC application 31 is an application program that displays an application setting screen D illustrated in FIG. 9, generates a print job, and the like. The printer driver 32 is a software program for controlling the tape printing apparatus 2. The printer driver 32 displays a print setting screen on which a user selects a cut setting on the PC display 11. On the print setting screen, the settings regarding the tape T and the print quality are made in addition to the cut setting.

The tape printing apparatus 2 includes a printer communication section 41, a printer controller 43, and a print section 44.

The printer communication section 41 communicates with the PC 1 via the cable 5.

The printer controller 43 includes a printer CPU 43a, a printer ROM 43b, and a printer RAM 43c.

The printer ROM 43b stores firmware which is a control program. The printer CPU 43a performs various kinds of control by loading the firmware stored in the printer ROM 43b onto the printer RAM 43c and executing the firmware. In this regard, the printer controller 43 may use hardware circuit such as an ASIC or the like as a processor instead of the printer CPU 43a. Also, the processor may have a configuration in which one or more CPUs and a hardware circuit such as an ASIC or the like work in combination.

The printer CPU 43a performs printing on the tape T fed out from the tape cartridge C by using the firmware stored in the printer ROM 43b in accordance with the print job transmitted from the PC 1.

The print section 44 is a mechanism for printing on the tape T and includes the thermal head 26, a feed motor 44a, the platen drive shaft 25, a cutter motor 44b, the half cutter 27a, and the full cutter 27b.

The thermal head 26 includes a plurality of heating elements and performs printing by thermally transferring ink from the ink ribbon R onto the tape T. The feed motor 44a is a drive source that drives the platen drive shaft 25. The feed motor 44a feeds the tape T and the ink ribbon R in the −X-direction by rotating the platen roller 17 via the platen drive shaft 25. The cutter motor 44b is a drive source that drives the half cutter 27a and the full cutter 27b. In this regard, the tape printing apparatus 2 may individually include a cutter motor that drives the half cutter 27a and a cutter motor that drives the full cutter 27b.

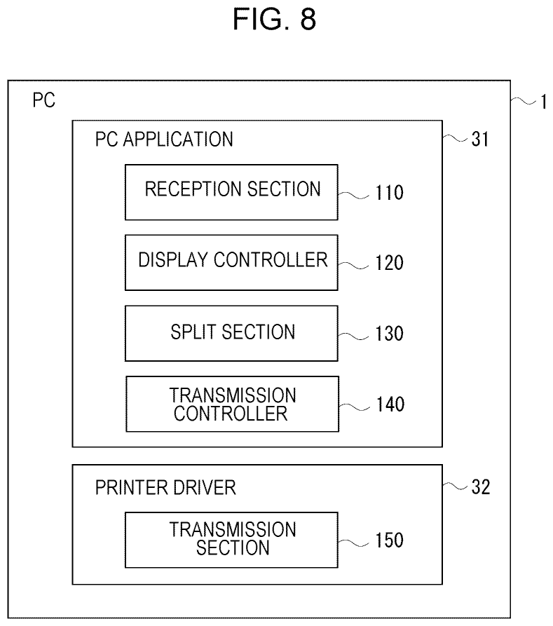

A description will be given of the functional configuration of the PC 1 with reference to FIG. 8. The PC 1 includes a reception section 110, a display controller 120, a split section 130, a transmission controller 140, and a transmission section 150. Among these, the reception section 110, the display controller 120, the split section 130 and the transmission controller 140 are the functions that are realized by the PC CPU 14a running the PC application 31. Also, the transmission section 150 is the function realized by the PC CPU 14a running the printer driver 32.

The reception section 110 receives a setting value y indicating into how many pieces to split a plurality of labels L to be printed in accordance with the print job. In the present embodiment, when the user requests to create a plurality of label sets LS, the reception section 110 receives the value y. Specifically, when the user selects to split a print job in a split printing check field 71 on the application setting screen D illustrated in FIG. 9, the reception section 110 receives the setting value y in the number of splits setting field 72. Hereinafter splitting a print job to create a plurality of label sets LS is referred to as “split printing”. That is, whether or not to perform split printing is selected in the split printing check field 71.

The display controller 120 displays the application setting screen D on the PC display 11. A visual image 73 illustrated in FIG. 9 is displayed on the application setting screen D. The visual image 73 is an image including one or more labels L and indicating that a plurality of label sets LS with a half cut between labels are to be created. It is possible for the user to understand that a plurality of label sets LS as illustrated in the visual image 73 are created by performing split printing from the visual image 73.

The split section 130 splits a print job to print a plurality of labels L on the tape printing apparatus 2 into a plurality of split print jobs. Hereinafter the number of a plurality of labels L to be printed in accordance with the print job is referred to as a “total number x of prints”. In the present embodiment, when the user selects to perform split printing in the split printing check field 71 of the application setting screen D, and selects a number smaller than the total number x of prints as the number y of splits in the number of splits setting field 72, the split section 130 splits the print job into a plurality of split print jobs.

When the split section 130 receives the setting value y from the reception section 110, in a case in which there is no remainder in x/y, the split section 130 splits the print job into x/y split print jobs, whereas in a case in which there is a remainder in x/y, the split section 130 splits the print job into ([x/y]+1) split print jobs. In this regard, “[ ]” is a Gauss symbol, and [x/y] denotes a maximum integer value not exceeding x/y. Specifically, when there is a remainder in x/y, the split section 130 splits the print job into ([x/y]+1) split print jobs in total, which include x/y split print jobs that print a plurality of the individual labels L spilt into y pieces from the beginning, and one split print job that prints one or more labels L that are leftover at the end. In this regard, the processing performed by the split section 130 is an example of the “splitting”.

When the split section 130 splits a print job, and in a case in which the cut setting of the transmission section 150 realized by the printer driver 32 is not the first cut setting, the transmission controller 140 changes the cut setting of the transmission section 150 to the first cut setting. Thereby, the transmission controller 140 controls the transmission section 150 so that the transmission section 150 individually adds the first cut information to a plurality of the split print jobs, and a plurality of the individual split print jobs with the first cut information added are transmitted to the tape printing apparatus 2. As described above, the first cut information is the information that instructs the tape printing apparatus 2 to perform the full cut at the rear end of the label L to be printed last among one or more labels L to be printed in accordance with the split print jobs, and perform the half cut between labels of a plurality of labels L when a plurality of labels L are printed in accordance with the split print jobs. In this regard, the processing performed by the transmission controller 140 is an example of the “transmission controlling”.

Any one of a plurality of cut settings including the first cut setting and the second cutting setting is set in the transmission section 150. In the present embodiment, any one of the first cut setting, the second cutting setting, and the third cut setting is set in the transmission section 150. Also, when the split section 130 splits a print job, the transmission section 150 transmits a plurality of the individual split print jobs with the first cut information added to the tape printing apparatus 2. In this regard, the processing performed by the transmission section 150 is an example of the “transmitting”.

A description will be given of the application setting screen D with reference to FIG. 9. The application setting screen D is a screen displayed on the PC display 11 by instructing to print on the edit screen for editing a label L.

As illustrated in FIG. 9, the application setting screen D includes a first area E1, a second area E2, and a third area E3. In the first area E1, a printer setting field 61, the number of copies setting field 62, a print setting button 63, and a special printing button 64 are displayed. The PC 1 generates a print job in accordance with an editing result of the label L on the edit screen and the setting in the first area E1.

In the printer setting field 61, the model of a printer to be the transmission destination of the print job is set.

In the number of copies setting field 62, the number of copies is set. For example, when editing for printing 3 labels L is performed on the edit screen, in a case in which the number of copies is set to “2 copies”, the number of pieces to print the label L, that is, the total number x of prints becomes “6 pieces”.

The print setting button 63 is a button for setting the printer driver 32. When the print setting button 63 is selected, the PC 1 displays a print setting screen not illustrated in the figure on the PC display 11. As described above, on the print setting screen, the settings regarding the tape T and the print quality are made in addition to the cut setting.

The special printing button 64 is a button for making a special print setting. When the special printing button 64 is selected, the PC 1 displays a special printing screen not illustrated in the figure on the PC display 11. On the special printing screen, the settings, such as serial number printing, pour printing, or the like are made. In this regard, the serial number printing is the function of consecutively printing a plurality of label images G on the tape T by changing a number or a character, for example, “first”, “second”, “third”, or the like in accordance with regularity. Also, the pour printing is the function of consecutively printing a plurality of label images G corresponding to the individual row data in accordance with tabular data including a plurality of row data on the tape T.

The second area E2 is an area in which the setting on the split printing is made. In the second area E2, a split printing check field 71, the number of splits setting field 72, a visual image 73, and a message 74 are displayed.

In the split printing check field 71, whether or not to perform split printing is selected. When the split printing check field 71 is checked, the PC 1 determines that performing split printing is selected, whereas when the split printing check field 71 is not checked, the PC 1 determines that performing split printing is not selected.

In the number of splits setting field 72, the number y of splits is set. In the number of splits setting field 72, it is possible to set the number of 1 or more even when the number is equal to or more than the total number x of prints. In this regard, even when the split printing check field 71 is checked, in a case in which the number y of splits set in the number of splits setting field 72 is equal to or more than the total number x of prints, the PC 1 does not split the print job.

As described above, the visual image 73 is an image indicating that a plurality of label sets LS are created. In the present embodiment, the visual image 73 is a fixed image and does not change in accordance with whether or not the split printing check field 71 is checked and in accordance with the setting value in the number of splits setting field 72. The visual image 73 illustrated in FIG. 9 includes three label set images 73a, each of which is imitating a label set LS including two labels L. Also, the visual image 73 illustrated in FIG. 9 indicates that the half cut is performed between the labels of a label set LS by a rolled-up image 73b indicating a partially rolled-up state of the tape T. Also, the visual image 73 illustrated in FIG. 9 indicates that the full cut is performed at the rear end of the label set LS by scissors images 73c disposed between label sets LS.

The message 74 is a message on the split printing to the user. Specifically, the message 74 is the message stating that when split printing is performed, the full cut is performed every time the number y of splits, which is set in the number of splits setting field 72, of the labels L are printed, and when split printing is performed, the cut setting in the printer driver 32 is automatically changed to the first cut setting.

In the third area E3, a print button 75 and a cancel button 76 are displayed. When the print button 75 is selected, the PC 1 generates a print job. Also, when the print button 75 is selected, and the print job is to be split, the PC 1 splits the print job into a plurality of split print jobs and adds the first cut information to a plurality of the individual split print jobs. The PC 1 then transmits a plurality of split print jobs, each of which with the first cut information added, to the tape printing apparatus 2. Also, when the print button 75 is selected, and the print job is not to be split, the PC 1 adds the cut information corresponding to the cut setting set in advance to the print job. The PC 1 then transmits the print job with the cut information added to the tape printing apparatus 2.

Also, when the cancel button 76 is selected, the PC 1 cancels the setting of the application setting screen D and hides the application setting screen D.

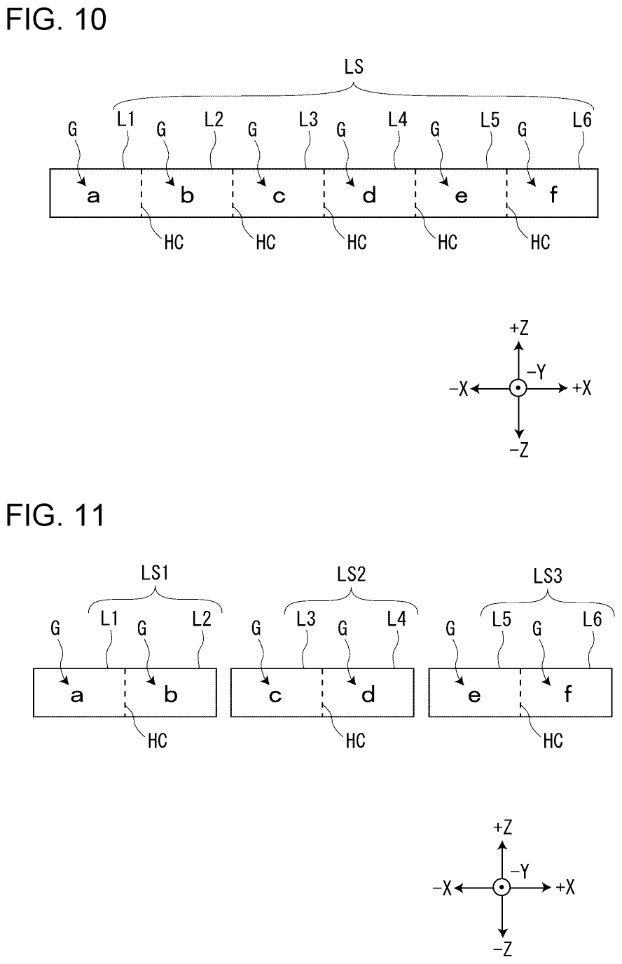

A description will be given of a label creation result performed by split printing by taking a specific example with reference to FIG. 10 to FIG. 12. Here, a description will be given of the case where 6 labels L from a first label L1 to a sixth label L6 are created. Also, here an example in which one copy of 6 labels L including label images G from a character “a” to a character “f” is printed. However, when the total number x of prints is the same, in the case in which 2 copies of 3 labels L are printed, or in the case in which 3 copies of 2 labels L are printed, the splitting the print job is performed in the same manner.

FIG. 10 is a diagram illustrating an example of label creation when the setting, in which the total number x of prints is 6, and the number y of splits is 6 or more, is made in the split printing. In this case, since the number y of splits is equal to or more than the total number x of prints, the print job is not split, the PC 1 transmits a print job that prints 6 labels L from the first label L1 to the sixth label L6 to the tape printing apparatus 2. As a result, as illustrated in FIG. 10, one label set LS including 6 labels L from the first label L1 to the sixth label L6 is created.

FIG. 11 a diagram illustrating an example of label creation when the setting, in which the total number x of prints is 6, and the number y of splits is 2, is made in the split printing. In this case, the PC 1 splits 6 labels L into 2 pieces from the first label L1 to be printed first. In this case, there is no remainder in x/y, that is, when the total number “6” of prints is divided by the number “2” of splits, and thus the PC 1 splits the print job into x/y, that is, 3 split print jobs. Specifically, the PC 1 splits the print job into a first split print job that prints the first label L1 and the second label L2, a second split print job that prints the third label L3 and the fourth label L4, and a third split print job that prints the fifth label L5 and the sixth label L6. As a result, as illustrated in FIG. 11, 3 label sets LS including a first label set LS1 based on the first split print job, a second label set LS2 based on the second split print job, and a third label set LS3 based on the third split print job are created.

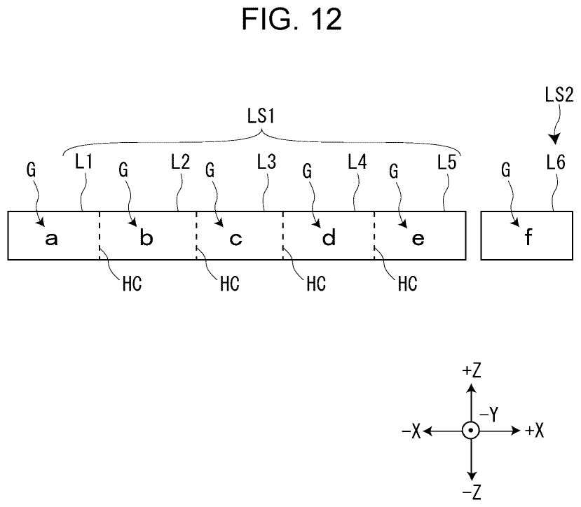

FIG. 12 a diagram illustrating an example of label creation when the setting, in which the total number x of prints is 6, and the number y of splits is 5, is made in the split printing. In this case, there is a remainder in x/y, that is, when the total number “6” of prints is divided by the number “5” of splits, and thus the print job is split into ([x/y]+1) split print jobs, that is, 2 split print jobs. Specifically, the PC 1 splits the print job into a first split print job that prints the first label L1 to the fifth label L5 and a second split print job that prints the sixth label L6. As a result, as illustrated in FIG. 12, two label sets LS, that is, a first label set LS1 based on the first split print job and a second label set LS2 based on the second split print job, are created. In this regard, when the label set LS includes one label L as in the case of the second label set LS2, there are no “between labels”, and thus the half cut is not performed.

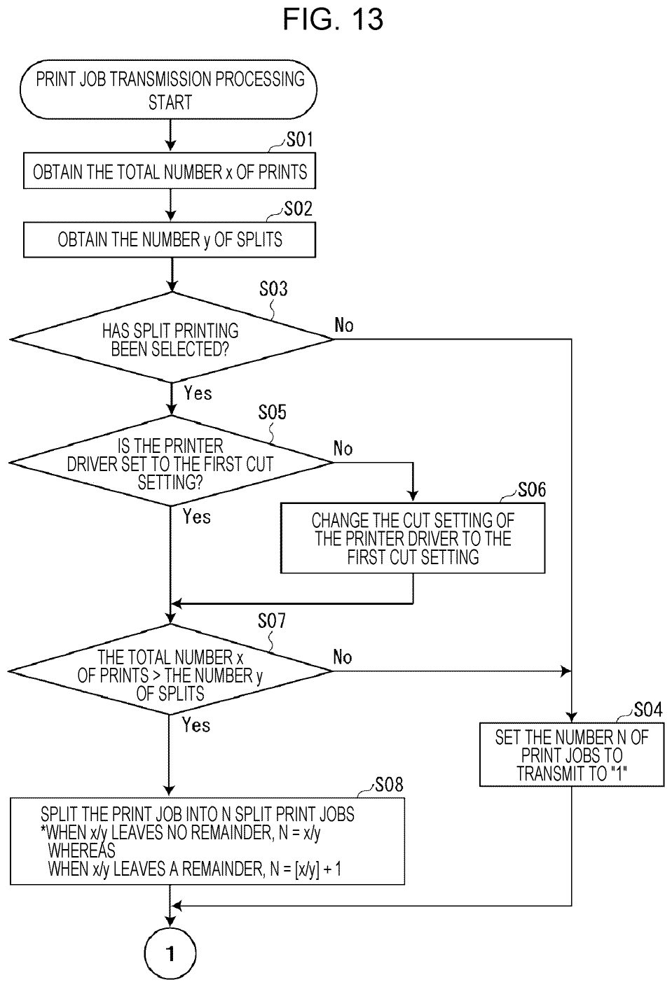

A description will be given of the print job transmission processing performed by the PC 1 with reference to FIG. 13 to FIG. 15. The PC 1 starts the print job transmission processing by using the selection of the print button 75 on the application setting screen D as a trigger.

In step S01, the PC 1 obtains the total number x of prints. The PC 1 obtains the product of the number of labels L edited on an edit screen, not illustrated in the figure, for editing a label L, and the number of copies set in the number of copies setting field 62 on the application setting screen D illustrated in FIG. 9, as the total number x of prints. In this regard, when the serial number printing or the pour printing is set on the application setting screen D, the PC 1 obtains the product of the number of labels L set as the serial number printing or the pour printing, and the number of copies set in the number of copies setting field 62, as the total number x of prints.

In step S02, the PC 1 obtains the number y of splits. The PC 1 obtains a setting value in the number of splits setting field 72 illustrated in FIG. 9 as the number y of splits.

In step S03, the PC 1 determines whether or not performing split printing has been selected. The PC 1 determines whether or not performing split printing has been selected in accordance with a check result of the split printing check field 71. When it is determined that performing split printing has been selected, the PC 1 proceeds to step S05. Whereas when it is determined that performing split printing is not selected, the PC 1 proceeds to step S04.

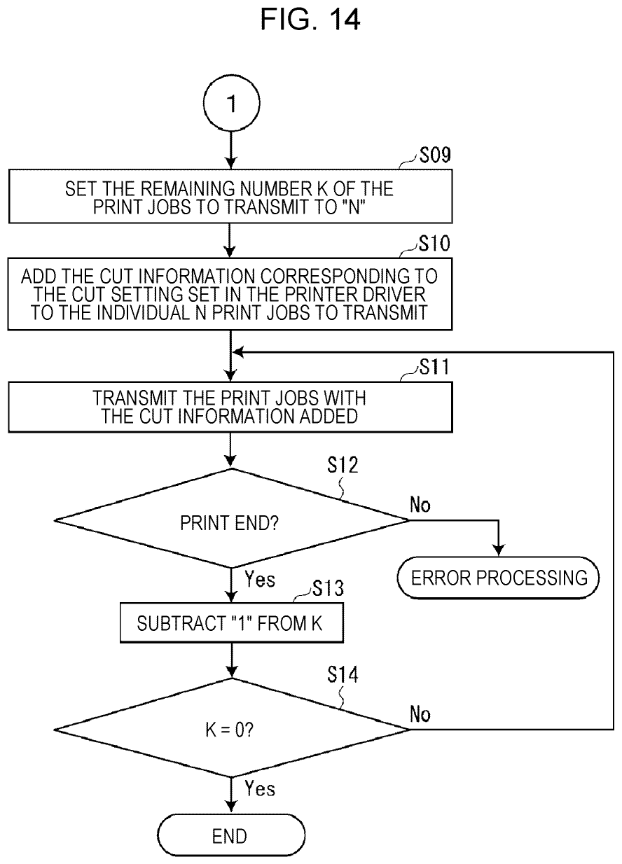

In step S04, the PC 1 sets the number N of print jobs to transmit to “1”. In this case, the split section 130 illustrated in FIG. 8 does not split the print job. After the processing in step S04, the PC 1 proceeds to step S09 in FIG. 14.

In step S05, the PC 1 determines whether or not the cut setting in the printer driver 32 is the first cutting setting. When it is determined that the cut setting in the printer driver 32 is the first cut setting, the PC 1 proceeds to step S07. Whereas when it is determined that the cut setting in the printer driver 32 is not the first cut setting, the PC 1 proceeds to step S06.

In step S06, the PC 1 changes the cut setting in the printer driver 32 to the first cut setting.

In step S07, the PC 1 determines whether or not the total number x of prints is larger than the number y of splits. When the PC 1 determines that the total number x of prints is larger than the number y of splits, the processing proceeds to step S08. Whereas when the PC 1 determines that the total number x of prints is not larger than the number y of splits, the processing proceeds to step S04.

In step S08, the PC 1 splits the print job into N split print jobs. In this case, the PC 1 transmits N split print jobs to the tape printing apparatus 2, and thus the number of print jobs to transmit becomes N. When there is no remainder in x/y, the PC 1 splits the print job into x/y. Whereas when there is a remainder in x/y, the PC 1 splits the print job into [x/y]+1. After the processing in step S08, the processing of the PC 1 proceeds to step S09 in FIG. 14.

In step S09 in FIG. 14, the PC 1 sets a remaining number K of print jobs to transmit to “N”.

In step S10, the PC 1 adds the cut information corresponding to the cut setting set in the printer driver 32 to the individual N print jobs to transmit.

In step S11, the PC 1 transmits the print jobs with the cut information added to the tape printing apparatus 2.

In step S12, the PC 1 determines whether or not the printing based on the print job has ended. When the PC 1 receives a response signal stating that the printing based on the print job has ended normally from the tape printing apparatus 2, the PC 1 determines that the printing based on the print job has ended. Whereas when the PC 1 does not receive a response signal from the tape printing apparatus 2 even after predetermined time has elapsed, or receives an error signal stating that the printing based on the print job has not ended normally from the tape printing apparatus 2, the PC 1 determines that the printing based on the print job has not ended. When the PC 1 determines that the printing based on the print job has ended, the processing proceeds to step S13. Whereas when the PC 1 determines that the printing based on the print job has not ended, the PC 1 performs error processing.

In step S13, the PC 1 subtracts “1” from K.

In step S14, the PC 1 determines whether or not K has become “0”. When the PC 1 determines that K has become “0”, the PC 1 ends the print job transmission processing. Whereas when the PC 1 determines that K has not become “0”, the processing returns to step S11.

As described above, when split printing is performed, the PC 1 according to the present embodiment transmits a plurality of split print jobs produced by splitting a print job, each of the plurality of split print jobs with the first cut information added, to the tape printing apparatus 2. Thereby, even when the tape printing apparatus 2 is not able to perform two kinds of cutting between labels in accordance with one print job, the PC 1 is able to create a plurality of label sets LS in accordance with one print job. Also, thereby the user is able to obtain a plurality of label sets LS in accordance with a print job without changing the firmware of the tape printing apparatus 2.

Also, the PC 1 receives the setting number y of splits, and splits a print job for printing x labels into x/y or ([x/y]+1) split print jobs in accordance with the received setting number y of splits. Thereby, the user is able to set the number of labels included in a label set LS to a desired number of pieces.

Also, the PC 1 displays the visual image 73 on the application setting screen D. Thereby, the user is able to understand from the visual image 73 that when split printing is performed, a plurality of label sets LS, each of which including one or more labels L with the half cut between labels, are created.

Also, when the PC 1 performs split printing, by changing the cut setting of the transmission section 150 realized by the printer driver 32 to the first cut setting, the PC 1 individually adds the first cut information to a plurality of the individual split print jobs. Thereby when the user wants to perform split printing, it is possible to save time and effort for manually changing the cut setting. Also, since it is not necessary for the user to change the cut setting, it is possible to prevent mistakes in the cut setting. Also, since the cut setting is changed by the function of the PC application 31, the user is able to obtain a plurality of label sets LS in accordance with one print job without changing the printer driver 32.

It is possible to employ the following variations in addition to the embodiments described above.

### First Variation

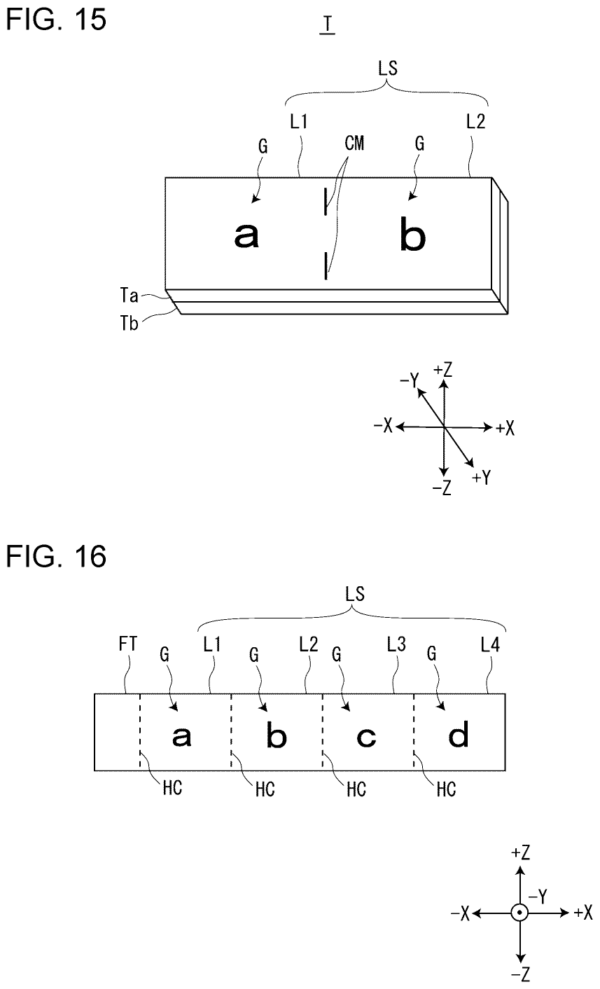

The PC 1 may print a cut mark CM on the tape T as illustrated in FIG. 15 instead of performing the half cut on the tape T. Printing the cut mark CM is an example of the “boundary formation processing”. In FIG. 15, two short solid lines extending in the Z-direction are disposed with a space therebetween in the Z-direction as the cut mark CM. However, a long solid line extending in the Z-direction or a broken line may be used, and its form does not matter. Also, when split printing is performed, the PC 1 determines whether or not the printer is able to perform the half cut. When the printer is able to perform the half cut, the PC 1 adds the cut information instructing to perform the half cut between labels to the split print jobs. Whereas when the printer is not able to perform the half cut, the PC 1 may add the information instructing to print a cut mark CM between labels to the split print jobs. In this case, the PC 1 may determine whether or not a printer to be a communication destination is able to perform the half cut in accordance with the model of the printer set in the printer setting field 61.

### Second Variation

As illustrated in FIG. 16, the tape printing apparatus 2 may form a half cut margin FT at the time of creating a label set LS. The half cut margin FT is formed at the end in the −X-direction of the tape T, and the half cut is performed at the end thereof in the +X-direction. In the present variation, when the tape printing apparatus 2 obtains a print job with the first cut information added, the tape T is fed in the −X-direction by the length in the X-direction of the half cut margin FT, and then the half cut is performed on the tape T so that the half cut margin FT is formed. Accordingly, in the present variation, not the full cut but the half cut is performed at the front end of the first label L1. Also, in the present variation, the tape printing apparatus 2 may determine whether or not to form the half cut margin FT in accordance with the margin length of the first label L1. The margin length of the first label L1 refers to the length from the front end of the first label L1 to the end of the label image G in the −X-direction printed on the first label L1. For example, when the tape printing apparatus 2 obtains a print job with the first cut information added, in a case in which the margin length of the first label L1 is shorter than a first distance set in advance, the tape printing apparatus 2 may form a half cut margin FT, whereas when the margin length of the first label L1 is equal to or more than the first distance, the tape printing apparatus 2 may not form the half cut margin FT. The first distance is, for example, a distance between the thermal head 26 and the full cutter 27b in the X-direction in the state in which the tape cartridge C is loaded onto the cartridge loading section 23. In this manner, when the margin length of the first label L1 is set shorter than the first distance set in advance, by forming a half cut margin FT, it is possible to make effective use of the margin that arises at the end in the −X-direction of the tape T. That is, in the tape printing apparatus, since the full cutter 27b is located at the position away in the −X-direction from the thermal head 26, a printing impossible area with the length equal to the distance between the thermal head 26 and the full cutter 27b in the X-direction arises at end in the −X-direction of the tape T. With this configuration, the tape printing apparatus 2 is able to use the printing impossible area as the half cut margin FT. Also, when the margin length of the first label L1 is equal to or more than the first distance, by not forming the half cut margin FT, it is possible to reduce the consumption of the tape T.

### Third Variation

When the PC 1 performs split printing in the print job transmission processing, in a case in which the cut setting of the printer driver 32 is not the first cut setting, the PC 1 changes the cut setting of the printer driver 32 to the first cut setting as illustrated in S06 in FIG. 13. However, the PC 1 may display a dialog asking the user whether or not to change the cut setting before changing the cut setting. When the user performs an operation on the dialog to change the cut setting, the PC 1 may change the cut setting of the printer driver 32 to the first cut setting, whereas when the user performs an operation not to change the cut setting, the PC 1 may cancel the printing. In this regard, when the user performs an operation not to change the cut setting on the dialog, the PC 1 may display an error and display a message instructing the user to change the cut setting of the printer driver 32 to the first cut setting. Also, when performing the split printing, in a case in which the cut setting of the printer driver 32 is not the first cut setting, the PC 1 may display an error without displaying a dialog. In this case, until the PC 1 confirms that the user has changed the cut setting of the printer driver 32 to the first cut setting, the PC 1 may not allow the selection of the print button 75. Also, the PC 1 may perform the confirmation of the cut setting of the printer driver 32 and the display of the dialog not at the time when the print button 75 is selected, but at the time when the split printing check field 71 is checked. When the user performs an operation to change the cut setting on the dialog, the PC 1 ought to change the cut setting of the printer driver 32 to the first cut setting, whereas when the user performs an operation not to change the cut setting, the PC 1 ought to display an error.

### Fourth Variation

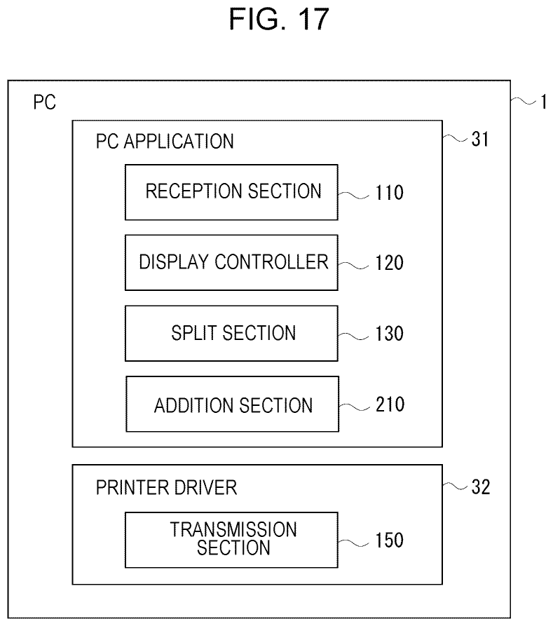

The PC 1 may have a functional configuration illustrated in FIG. 17. In the present variation, the addition section 210 is realized by the PC application 31. When split printing is performed, the addition section 210 individually adds the first cut information to a plurality of split print jobs. In this manner, the first cut information may be added to the split print jobs by the function of the PC application 31. In this case, the transmission section 150 transmits a plurality of split print jobs, each of which with the first cut information added by the addition section 210, to the tape printing apparatus 2. In this regard, the processing performed by the addition section 210 is an example of the “adding”.

### Fifth Variation

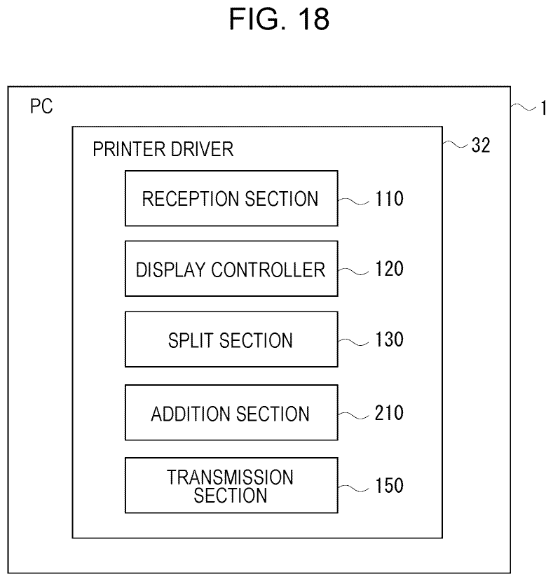

The PC 1 may have a functional configuration illustrated in FIG. 18. In the present variation, the reception section 110, the display controller 120, the split section 130, the addition section 210, and the transmission section 150 are realized by the printer driver 32. The addition section 210 has the same function as that in the fourth variation. In the present variation, the setting as to whether or not to perform split printing and the setting of the number y of splits are made on the setting screen of the printer driver 32. Also, in the present variation, the transmission section 150 transmits a plurality of split print jobs, each of which with the first cut information added by the addition section 210, to the tape printing apparatus 2. In this manner, the individual functions described above may be realized not by the PC application 31 but by the printer driver 32. In the present variation, the printer driver 32 is an example of the “program”.

### Sixth Variation

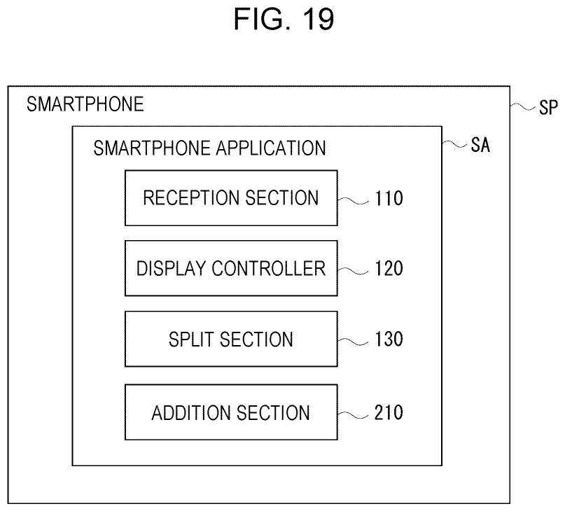

Instead of the PC 1, the “information processing apparatus” may be an information processing terminal that does not require the printer driver 32. As an information processing terminal that does not require the printer driver 32, a smartphone SP with some operation system is considered. In this case, the smartphone SP has the functional configuration as illustrated in FIG. 19. Also, as illustrated in FIG. 19, the reception section 110, the display controller 120, the split section 130, and the addition section 210 are realized by a smartphone application SA installed in the smartphone SP. The addition section 210 has the same function as that in the fourth variation. In the present variation, the smartphone application SA is an example of the “program”.

### Seventh Variation

The PC 1 may display a variable image that changes in accordance with an editing result of the label L on the edit screen and the setting of the application setting screen D instead of the visual image 73 displayed in the embodiment described above. Specifically, it is desirable that the variable image be an image that changes in accordance with the total number x of prints and the number y of splits. Also, it is desirable that the variable image be an image in which the half cut is performed between labels, and the full cut is performed for each label set LS when a plurality of labels L are included in a label set LS. For example, as illustrated in FIG. 11, the PC 1 may display a label image after having been half cut and the full cut as the variable image.

### Eighth Variation

When the PC 1 performs pour printing, the PC 1 may divide tabular data into groups in advance, and then generate a print job that creates label sets LS corresponding to each group. Specifically, the PC 1 may divide the cell data for each column of the tabular data and may automatically set the number of cell data included in a column as the number y of splits. For example, when the PC 1 performs pour printing on tabular data including 3 rows×2 columns, the PC 1 may divide 6 cell data into 2 groups per column and may generate a print job that creates 2 label sets LS, each of which includes 3 labels L. With this configuration, the PC 1 is able to generate a print job that creates label sets LS for the number of columns in the tabular data. Also, the PC 1 may automatically set the number of labels per copy as the number y of splits when printing a plurality of copies. With this configuration, the PC 1 is able to generate a print job that creates the set number of copies of label sets LS.

### Ninth Variation

The tape T is not limited to have the two-layer structure, and may have a one-layer structure. However, when the tape T has a one-layer structure, the printing of a cut mark CM is performed as the boundary formation processing. Also, the PC application 31, the printer driver 32, or the smartphone application SA may be provided to a customer as a program. Also, a storage medium recording the PC application 31, the printer driver 32, or the smartphone application SA may be provided to the customer.

In addition, suitable changes may be made without departing from the spirit and scope of the present disclosure.

### APPENDIXES

In the following, additional descriptions will be given of the information processing apparatus, the control method of the information processing apparatus, the printing system, and the non-transitory computer-readable storage medium storing the program.

A PC 1 configured to communicate with a tape printing apparatus 2 configured to perform feeding operation of a tape T in the −X-direction, printing on the tape T, a full cut of the tape T, and boundary formation processing forming a boundary between labels on the tape T, the PC 1 including: a split section 130 configured to split a print job causing the tape printing apparatus 2 to print a plurality of labels L into a plurality of split print jobs; a transmission section 150 configured to transmit a plurality of split print jobs to the tape printing apparatus 2, wherein the transmission section 150 performs the full cut at an end in the +X-direction of the label L to be printed last among one or more of the labels L to be printed in accordance with the split print jobs, and when a plurality of labels L are printed in accordance with the split print jobs, the transmission section 150 transmits a plurality of split print jobs, the individual split print jobs with added first cut information instructing the tape printing apparatus 2 to perform the boundary formation processing between labels of a plurality of labels L, to the tape printing apparatus 2.

A control method of a PC 1 configured to communicate with a tape printing apparatus 2 configured to perform feeding operation of a tape T in the −X-direction, printing on the tape T, a full cut of the tape T, and boundary formation processing forming a boundary between labels on the tape T, the control method causing the PC 1 to perform processing including: splitting a print job causing the tape printing apparatus 2 to print a plurality of labels L into a plurality of split print jobs; and transmitting a plurality of split print jobs to the tape printing apparatus 2, wherein in the transmitting, performing the full cut at an end in the +X-direction of the label L to be printed last among one or more of the labels L to be printed in accordance with the split print jobs, and when a plurality of labels L are printed in accordance with the split jobs, transmitting a plurality of split print jobs, the individual split print jobs with added first cut information instructing the tape printing apparatus 2 to perform the boundary formation processing between labels of a plurality of the labels L, to the tape printing apparatus 2.

A printing system SY including a tape printing apparatus 2 configured to perform feeding operation of a tape T in the −X-direction, printing on the tape T, a full cut of the tape T, and boundary formation processing forming a boundary between labels on the tape T, and a PC 1 configured to communicate with the tape printing apparatus 2, the PC 1 including: the split section 130 configured to split a print job causing the tape printing apparatus 2 to print a plurality of labels L into a plurality of split print jobs; and the transmission section 150 configured to transmit a plurality of the split print jobs to the tape printing apparatus 2, wherein the transmission section 150 performs the full cut at an end in the +X-direction of the label L to be printed last among one or more labels L to be printed in accordance with the split print jobs, and when a plurality of labels L are printed in accordance with the split print jobs, the transmission section 150 transmits a plurality of split print jobs, the individual split print jobs with added first cut information instructing the tape printing apparatus 2 to perform boundary formation processing between labels of a plurality of labels L, to the tape printing apparatus 2.

A non-transitory computer-readable storage medium storing a program, the program causing a PC 1 configured to communicate with a tape printing apparatus 2 configured to perform feeding operation of a tape T in the −X-direction, printing on the tape T, a full cut of the tape T, and boundary formation processing forming a boundary between labels on the tape T to perform processing including: splitting a print job causing the tape printing apparatus 2 to print a plurality of labels L into a plurality of split print jobs, and transmission controlling of the transmission section 150 so that a plurality of split print jobs are transmitted to the tape printing apparatus 2, wherein in the transmission controlling, performing the full cut at an end in the +X-direction of the label L to be printed last among one or more labels L to be printed in accordance with the split print jobs, and when a plurality of the labels L are printed in accordance with the split print jobs, controlling the transmission section 150 so that the transmission section 150 adds first cut information instructing the tape printing apparatus 2 to perform the boundary formation processing between labels of a plurality of the labels L to the individual split print jobs, and transmits a plurality of the split print jobs with the first cut information added, to the tape printing apparatus 2.

A non-transitory computer-readable storage medium storing a program, the program causing a PC 1 configured to transmit a print job to a tape printing apparatus 2 configured to perform feeding operation of the tape T in the −X-direction, printing on the tape T, a full cut of the tape T, and boundary formation processing forming a boundary between labels on the tape T, to perform processing including: splitting a print job causing the tape printing apparatus 2 to print a plurality of labels L into a plurality of split print jobs; performing the full cut at an end in the +X-direction of the label L to be printed last among one or more of the labels L to be printed in accordance with the split print jobs, and when a plurality of the labels L are printed in accordance with the split print jobs, adding first cut information instructing the tape printing apparatus to perform the boundary formation processing between labels of a plurality of the labels L to a plurality of the individual split print jobs.

With this configuration, the PC 1 transmits a plurality of split print jobs produced by splitting a print job, the individual split print jobs with the first cut information added, to the tape printing apparatus 2. Thereby, when the tape printing apparatus 2 is not able to perform two kinds of cut and processing between labels in accordance with one print job, the PC 1 is able to cause tape printing apparatus 2 to print a plurality of label sets LS with a boundary formed between labels in accordance with one print job.

The PC 1 described above may further include a reception section 110 that receives a setting value y indicating into how many pieces to split a plurality of the labels L to be printed in accordance with the print job, wherein when a number of pieces of a plurality of the labels L is x, in a case in which there is no remainder in x/y, the split section 130 may split the print job into x/y the split print jobs, whereas in a case in which there is a remainder in x/y, the split section 130 may sprit the print job into ([x/y]+1) the split print jobs.

With this configuration, a user is able to set the value y to a desired value.

The PC 1 described above may further include a display controller 120 that displays a visual image 73 indicating that a plurality of label sets LS with a boundary formed between labels, the individual label sets LS including one or more of the labels L, are created on a display section.

With this configuration, the user is able to understand that a plurality of label sets LS, each of which includes one or more labels L with a boundary formed between labels, are created from the visual image 73.

The PC 1 described above may further include a transmission controller 140 configured to control the transmission section 150 such that the transmission section 150 has any one of a plurality of settings including a first cut setting to add the first cut information to the print job and a second cut setting to add the second cut information to perform the full cut at an end in the second direction of one or more of the labels L to the print job, and when the print job is split by the split section 130, and in a case in which the cut setting of the transmission section 150 is not the first cut setting, by changing the cut setting of the transmission section 150 to the first cut setting, the first cut information is added to a plurality of the individual split print jobs, and a plurality of the individual split print jobs with the first cut information added are transmitted to the tape printing apparatus 2.

With this configuration, the PC 1 is able to add the first cut information to a plurality of the individual split print jobs by changing the cut setting of the transmission section 150 to the first cut setting. Thereby, for example, when the transmission section 150 is realized by the printer driver 32, the PC 1 is able to obtain the advantages described above without requiring a change of the printer driver 32.

What is claimed is:

1. An information processing apparatus configured to communicate with a tape printing apparatus configured to perform feeding operation of a tape in a first direction, printing on the tape, a full cut of the tape, and boundary formation processing forming a boundary between labels on the tape, the information processing apparatus comprising:
a split section configured to split a print job causing the tape printing apparatus to print a plurality of labels into a plurality of split print jobs; and
a transmission section configured to transmit a plurality of the split print jobs to the tape printing apparatus, wherein
the transmission section performs the full cut at an end in a second direction opposite to the first direction of the label to be printed last among one or more of the labels to be printed in accordance with the split print jobs, and when a plurality of the labels are printed in accordance with the split print jobs, the transmission section transmits a plurality of the split print jobs, the individual split print jobs with added first cut information instructing the tape printing apparatus to perform the boundary formation processing between labels of a plurality of the labels, to the tape printing apparatus.

2. The information processing apparatus to claim 1, further comprising
a reception section that receives a setting value y indicating into how many pieces to split a plurality of the labels to be printed in accordance with the print job, wherein
when a number of pieces of a plurality of the labels is x, in a case in which there is no remainder in x/y, the split section splits the print job into x/y the split print jobs, whereas in a case in which there is a remainder in x/y, the split section splits the print job into ([x/y]+1) the split print jobs.

3. The information processing apparatus to claim 1, further comprising
a display controller that displays a visual image indicating that a plurality of label sets with a boundary formed between labels, the individual label sets including one or more of the labels, are created on a display section.

4. The information processing apparatus to claim 1, further comprising
a transmission controller configured to control the transmission section such that
the transmission section has any one of a plurality of settings including a first cut setting to add the first cut information to the print job and a second cut setting to add second cut information to perform the full cut at an end in the second direction of one or more of the labels to the print job, and
when the print job is split by the split section, and in a case in which the cut setting in the transmission section is not the first cut setting, by changing the cut setting of the transmission section to the first cut setting, the first cut information is added to a plurality of the individual split print jobs, and a plurality of the individual split print jobs with the first cut information added are transmitted to the tape printing apparatus.

5. A control method of an information processing apparatus configured to communicate with a tape printing apparatus configured to perform feeding operation of a tape in a first direction, printing on the tape, a full cut of the tape, and boundary formation processing forming a boundary between labels on the tape, the control method causing the information processing apparatus to perform processing comprising:
splitting a print job causing the tape printing apparatus to print a plurality of labels into a plurality of split print jobs; and
transmitting a plurality of the split print jobs to the tape printing apparatus, wherein,
in the transmitting,
performing the full cut at an end in a second direction opposite to the first direction of the label to be printed last among one or more of the labels to be printed in accordance with the split print jobs, and when a plurality of the labels are printed in accordance with the split print jobs, transmitting a plurality of the split print jobs, the individual split print jobs with added first cut information instructing the tape printing apparatus to perform the boundary formation processing between labels of a plurality of the labels, to the tape printing apparatus.

6. A printing system including a tape printing apparatus configured to perform feeding operation of a tape in a first direction, printing on the tape, a full cut of the tape, and boundary formation processing forming a boundary between labels on the tape, and an information processing apparatus configured to communicate with the tape printing apparatus, the information processing apparatus comprising:
a split section configured to split a print job causing the tape printing apparatus to print a plurality of labels into a plurality of split print jobs; and
a transmission section configured to transmit a plurality of the split print jobs to the tape printing apparatus, wherein
the transmission section performs the full cut at an end in a second direction opposite to the first direction of the label to be printed last among one or more of the labels to be printed in accordance with the split print jobs, and when a plurality of the labels are printed in accordance with the split print jobs, the transmission section transmits a plurality of the split print jobs, the individual split print jobs with added first cut information instructing the tape printing apparatus to perform the boundary formation processing between labels of a plurality of the labels, to the tape printing apparatus.

7. A non-transitory computer-readable storage medium storing a program, the program causing an information processing apparatus configured to communicate with a tape printing apparatus configured to perform feeding operation of a tape in a first direction, printing on the tape, a full cut of the tape, and boundary formation processing forming a boundary between labels on the tape to perform processing comprising:
splitting a print job causing the tape printing apparatus to print a plurality of labels into a plurality of split print jobs; and
transmission controlling of a transmission section so that a plurality of the split print jobs are transmitted to the tape printing apparatus, wherein
in the transmission controlling,
performing the full cut at an end in a second direction opposite to the first direction of the label to be printed last among one or more of the labels to be printed in accordance with the split print jobs, and when a plurality of the labels are printed in accordance with the split print jobs, controlling the transmission section so that the transmission section adds first cut information instructing the tape printing apparatus to perform the boundary formation processing between labels of a plurality of the labels to the individual split print jobs, and transmits a plurality of the split print jobs, the individual split print jobs with the first cut information added, to the tape printing apparatus.

8. A non-transitory computer-readable storage medium storing a program, the program causing an information processing apparatus configured to transmit a print job to a tape printing apparatus configured to perform feeding operation of a tape in a first direction, printing on the tape, a full cut of the tape, and boundary formation processing forming a boundary between labels on the tape, to perform processing comprising:
splitting a print job causing the tape printing apparatus to print a plurality of labels into a plurality of split print jobs;
performing the full cut at an end in a second direction opposite to the first direction of the label to be printed last among one or more of the labels to be printed in accordance with the split print jobs; and when a plurality of the labels are printed in accordance with the split print jobs,
adding first cut information instructing the tape printing apparatus to perform the boundary formation processing between labels of a plurality of the labels to a plurality of the individual split print jobs.
